(19) United States
(12) Patent Application Publication
(10) Pub. No.: US 2024/0246081 A1
(43) Pub. Date: Jul. 25, 2024

(54) HEAT STABLE LIQUID ANALYTICAL REAGENTS

(71) Applicant: Taylor Water Technologies LLC, Sparks, MD (US)

(72) Inventor: Brian Trice, Phoenix, MD (US)

(73) Assignee: Taylor Water Technologies LLC, Sparks, MD (US)

(21) Appl. No.: 18/417,306

(22) Filed: Jan. 19, 2024

Related U.S. Application Data
(60) Provisional application No. 63/439,972, filed on Jan. 19, 2023.

(51) Int. Cl. B01L 3/00

(52) U.S. Cl. CPC B01L 3/523; B01L 2200/04; B01L 2200/0689; B01L 2300/10; B01L 2300/12

(57) ABSTRACT

An apparatus for prolonging the stability of a liquid analytical reagent, even under high temperature storage is provided. The apparatus includes a first barrier forming all or a portion of an exterior of the apparatus, and a second barrier forming all or part of a second section within the apparatus. The first barrier includes a material having a permeability to oxygen of less than 50 cc/m2/24 hours, and the second barrier includes a material having a permeability to oxygen of 50 cc/m2/24 hours or more. A liquid analytical reagent is contained within the second section and an oxygen scavenger is separated from the liquid analytic reagent by the second barrier.

### CROSS-REFERENCE TO RELATED APPLICATIONS

This application claims the benefit and priority of U.S. Provisional Patent Application No. 63/439,972, entitled “HEAT STABLE LIQUID ANALYTICAL REAGENTS”, filed on Jan. 19, 2023, the contents of which are hereby incorporated by reference in their entirety.

### FIELD OF THE INVENTION

The present technology relates to methods and devices for maintaining the stability of liquid analytical reagents. The methods and devices may, although not exclusively, relate to liquid analytical reagents for water testing and maintenance.

### BACKGROUND

It is desirable and necessary to analyze water for various components. Water quality is important in a variety of industries. For example, pool maintenance requires periodic regular testing of pool water and careful maintenance by chemical additives. Depending upon the use to which the sample is to be put, one or more parameters, such as pH, total alkalinity, calcium hardness, total hardness, and amount of particular analytes such as total chlorine, free chlorine, combined chlorine, sodium content, etc., may be important. For example, when the water sample is taken from a swimming pool, either or both of combined chlorine and free chlorine may be important. Where the water is to be used for an industrial cooling system, total alkalinity or total hardness may be important. When the water is to be used in the health profession, any number of analytes may be of interest and important. These are just examples of the wide importance of water analysis.

Analysis of water samples can be accomplished with any number of different systems. Generally, however, these systems can be divided into “dry chemistry” and “wet chemistry” systems. In a wet chemistry system, a liquid testing agent or a dissolvable testing agent is added to a liquid sample. The testing agent reacts with the analyte of interest, leading to formation of a detectable signal. In dry chemistry systems, an apparatus, such as an absorbent pad or a test strip, is impregnated, coated, or printed with testing agents, such as those discussed above, in such a way that the test system does not and cannot leave the apparatus. The apparatus is then placed in contact with a liquid sample, and reacts with an analyte of interest, leading to formation of a detectable signal, similar to the wet chemistry methods.

However, the analytical reagents utilized for both wet and dry chemistry systems are susceptible to degradation from heat, moisture, and oxygen exposure. Attempts were made to package the reagents in anhydrous powders or tablets. While powder and tablet forms proved more shelf stable, oxidant analyzers, such as chlorine analyzers, require the analytes to be in liquid form. Efforts to overcome these deficiencies also included incorporating oxygen reducing compounds into liquid analytic reagents. However, known oxygen reducing compounds caused degradation of the reagents. Similarly, flushing containers with an inert gas during packaging failed to maintain the low to no oxygen environment over time, particularly after the container had been opened.

Therefore, it would be useful to provide shelf stable liquid analytical reagents and devices for maintaining the stability of such reagents.

### SUMMARY

The present technology is generally directed to one or more heat stable liquid analytical reagent apparatus. Apparatus include a first barrier forming all or a portion of an exterior of the apparatus, and a second barrier forming all or part of a second section within the apparatus. Apparatus include where the first barrier comprises a material having a permeability to oxygen of less than 50 cc/m²/24 hours, and the second barrier comprises a material having a permeability to oxygen of 50 cc/m²/24 hours or more. Apparatus include where a liquid analytical reagent is contained within the second section and an oxygen scavenger is separated from the liquid analytic reagent by the second barrier.

In embodiments, the first barrier, the second barrier, or both the first barrier and the second barrier are generally impermeable to liquids. In further embodiments, the second material is formed from a synthetic polymer. Moreover, in embodiments, the second material is a polyethylene, such as a low-density polyethylene. Additionally or alternatively, in embodiments, the first material is formed from a metallized or ceramically coated film or a polyethylene and polyamide copolymer. Embodiments include where the first material is a ceramically coated or metallized polyester. In yet more embodiments, the first barrier is in the form of a bottle, bag, or cartridge. In embodiments, the second barrier is in the form of a bottle, bag, tube, syringe, or cartridge. Furthermore, in embodiments, the second barrier is partially or wholly surrounded by the first barrier. In more embodiments, the liquid analytical reagent is an oxygen sensitive analytical reagent. In embodiments, the liquid analytical reagent is a pool or spa reagent.

The present technology is also generally directed to methods of prolonging functionality of liquid analytical reagents. Methods include placing an oxygen scavenger into a first section of a container formed from a first material. Methods include placing the liquid analytical reagent into a second section of the container. Methods include where a second material separates the first section from the second section, the first material has a permeability to oxygen of less than 50 cc/m²/24 hours, and the second material has a permeability to oxygen of 50 cc/m²/24 hours or more.

In embodiments, the container is not purged with an inert gas. In more embodiments, the second section is in the shape of a bottle, bag, tube, syringe, or cart. In further embodiments, the second section forms an enclosed structure. Additionally or alternatively, in embodiments, the liquid analytical reagent is placed into the second section prior to incorporation of the second section into the container. In yet more embodiments, the oxygen scavenger is an unsaturated polymer, and the oxygen scavenger is activated prior to incorporation into the first section. Embodiments include where the oxygen scavenger is configured to absorb all oxygen present in the container. In embodiments, the container is sealed after incorporation of the oxygen scavenger and the liquid analytical reagent, where the oxygen scavenger is present in an amount sufficient to absorb all oxygen present upon sealing. Furthermore, in embodiments, the oxygen scavenger is present in an amount sufficient to absorb oxygen introduced upon opening of the container.

### BRIEF DESCRIPTION OF THE DRAWINGS

A further understanding of the nature and advantages of the disclosed technology may be realized by reference to the remaining portions of the specification and the drawings.

FIG. 1 illustrates a stable liquid analytical reagent apparatus according to aspects of the present technology.

FIG. 2 illustrates a stable liquid analytical reagent apparatus according to aspects of the present technology.

FIG. 3 illustrates a stable liquid analytical reagent apparatus according to aspects of the present technology.

FIG. 4 is a graph illustrating stability over time according to Example 1.

FIG. 5 is a graph illustrating stability over time according to Example 2 at an initial concentration of 1.5 ppm.

FIG. 6 is a graph illustrating stability over time according to Example 2 at an initial concentration of 8 ppm.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

Generally speaking, the present technology is directed to a device configured to contain liquid analytical reagents in a low, to no, oxygen environment. Without wishing to be bound by theory, the present technology has found that by maintaining liquid analytical reagents in a low oxygen, to oxygen free, environment, both the shelf life and stability are significantly improved. Namely, the present disclosure has surprisingly found that, contrary to conventional wisdom in the art, a material having low oxygen barrier properties (e.g., high oxygen absorption rates), but that is not permeable to liquids, can be utilized to separate the liquid analytical reagent from an oxygen scavenger. Thus, as discussed herein, an oxygen scavenger and the liquid analytical reagent may be disposed in one container to provide a low, to no, oxygen environment, and substantially improve the stability of the liquid analytical reagent.

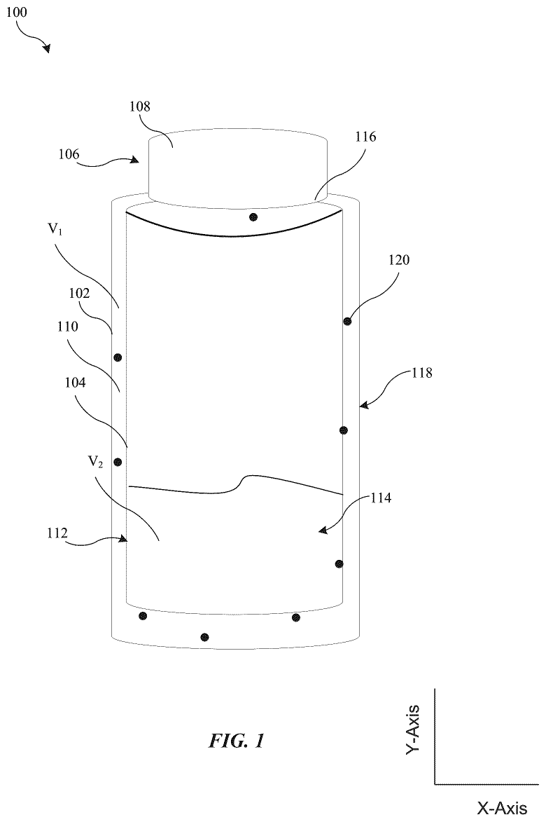

FIGS. 1 to 3 illustrates non-limiting examples of a stable liquid analytical reagent apparatus 100, 200, 300. As illustrated, in FIG. 1, the apparatus 100 has a first barrier 102, a second barrier 104, an opening 106, and a closure 108. In the exemplary figure, the first barrier 102 is shown as defining a first section 110 having a first volume V₁ between first barrier 102 and second barrier 104. However, it should be understood that in some aspects, the first barrier 102 may be a film disposed on or adjacent to second barrier 104, therefore defining little to no first section volume. Furthermore, as illustrated, inner barrier 104 may extend around an interior of the apparatus 100 and define a second section 112 having a second volume V₂. The second section 112 may be partially or fully occupied with a liquid analytical reagent 114.

Suitable liquid analytical reagents for disposition within second section 112 can be selected from any liquid reagent that reacts or degrades with atmospheric oxygen. For instance, the liquid analytical reagent may be an oxygen sensitive analytical reagent such as N,N diethyl-1,4 phenylenediamine sulfate (DPD), cerium (IV) ammonium nitrate (CAN), alkalinity P, ammonium molybdate, ammonium heptamolybdate, bromcresol green-methyl red, bromphenol blue, methyl orange, phenol red, diethylhydroxylamine, hydrogen peroxide, ammonium purpurate, thiosulfate, stannous chloride, ascorbic acid, zinc, tolidine, tetramethylbenzidine and the like, as well as combinations thereof. In some aspects, the liquid analytical reagent may be N,N diethyl-1,4 phenylenediamine sulfate (DPD), cerium (IV) ammonium nitrate (CAN), or a combination thereof.

In addition, while not shown, in some aspects, the first barrier 102 and/or second barrier 104 do not mirror one another around apparatus 100. For example, second barrier 104 may be disposed below opening 106, dividing apparatus neck 116 from the apparatus body 118. Furthermore, second barrier 104 may partition the apparatus 100 into first section 110 and second section 112 utilizing a line extending in a manner generally parallel to either the x or y axis, such that both the first section 110 and second section 112 may have one wall or side formed by first barrier 102 and a second wall or side formed by second barrier 104. In such an aspect, first barrier 102 may generally fully encompass or encircle second barrier 104. Of course, other manners of partitioning, such as angled lines, shapes, such as circles, and the like, may also be utilized with the understanding that two or more sections are formed within apparatus 100.

As noted above, in some aspects, the second barrier 104 is formed from a material that has a high permeability (e.g., low barrier) to oxygen. For instance, the second barrier 104 may have a permeability to oxygen of about 50 cc/m²/24 hours or more, as measured at 25° C. and 50% relative humidity, such as about 75 cc/m²/24 hours or more, such as about 100 cc/m²/24 hours or more, such as about 125 cc/m²/24 hours or more, such as about 150 cc/m²/24 hours or more, such as about 175 cc/m²/24 hours or more, such as about 200 cc/m²/24 hours or more, such as about 225 cc/m²/24 hours or more, such as about 250 cc/m²/24 hours or more, such as about 275 cc/m²/24 hours or more, such as about 300 cc/m²/24 hours or more, or any ranges or values therebetween.

Moreover, as noted above, the material forming the second barrier 104 is generally impermeable to liquids. Thus, the material of the second barrier 104 can restrict the flow of fluids through the material of the second barrier 104, and, in some aspects, be generally impermeable to fluids, thereby allowing the material to insulate a surface from liquid penetration. In this regard, the material of the second barrier 104 can have a relatively high hydrohead value of about 50 centimeters (cm) or more, such as about 100 cm or more, such as about 150 cm or more, about 200 cm or more, about 250 cm or more, about 500 cm or more, about 750 cm or more, about 1000 cm or more, about 5000 cm or less, or any ranges or values therebetween, as determined according to with ATTCC 127-2008.

By exhibiting the unique combination of high permeability to oxygen and low permeability to liquids, the material of the second barrier 104 may fluidly separate the liquid analytical reagent from the first section 110, while allowing oxygen to pass through the second barrier 104 and come into contact with an oxygen scavenger disposed in the first section 110. Thus, the section formed wholly or in part by inner wall 104 (e.g., second section 112 in the illustrated aspect) can be kept as a low, or no, oxygen environment. Therefore, in some aspects, the second section 112 may have an oxygen concentration of about 50 ppm or less, such as about 40 ppm or less, such as about 30 ppm or less, such as about 20 ppm or less, such as about 10 ppm or less, such as about 5 ppm or less, such as about 2.5 ppm or less, such as about 1 ppm or less, or any ranges or values therebetween. Furthermore, as discussed above, in some aspects, the second section 112 may be generally free of atmospheric or dissolved oxygen after sealing of apparatus 100.

While the material of the second barrier 104 may be formed from any material that exhibits one or more of the above properties, in some aspects, the material forming the second barrier 104 may include synthetic polymers, including polyolefins (such as polyethylene, polypropylene, polybutylene, and the like), polyesters (such as recycled polyester, polyethylene terephthalate, and the like), polyvinyl acetates (such as poly(ethylene vinyl acetate), polyvinyl chloride acetate, and the like), polyvinyl alcohols (such as polyvinyl alcohol, polyethylene vinyl alcohol), and the like); polyvinyl butyrals, polyvinyl chlorides, polyvinylidene chlorides, polystyrenes, as well as combinations and copolymers thereof. Suitable polyolefins may, for instance, include ethylene polymers such as low-density polyethylene (“LDRE”), high density polyethylene (“HDPE”), linear low-density polyethylene (“LLDPE”), and the like), propylene homopolymers (e.g., syndiotactic, atactic, isotactic, etc.), propylene copolymers, and so forth. In some aspects, the second barrier 104 may be formed from a polyethylene polymer, such as low-density polyethylene.

Regardless of the second barrier 104 material selected, the first barrier 102 is formed from a material that has a low permeability (e.g., high barrier) to oxygen. For instance, the first barrier 102 may have a permeability to oxygen of less than 50 cc/m²/24 hours, as measured at 25° C. and 50% relative humidity, such as about 45 cc/m²/24 hours or less, such as about 40 cc/m²/24 hours or less, such as about 35 cc/m²/24 hours or less, such as about 30 cc/m²/24 hours or less, such as about 25 cc/m²/24 hours or less, such as about 20 cc/m²/24 hours or less, such as about 15 cc/m²/24 hours or less, such as about 10 cc/m²/24 hours or less, or any ranges or values therebetween.

Moreover, as noted above, the material forming the first barrier 102 is also generally impermeable to liquids. Thus, the material of the first barrier 102 can restrict the flow of fluids through the material of the first barrier 102, and, in some aspects, be generally impermeable to fluids, thereby allowing the material to insulate a surface from liquid penetration. In this regard, the material of the first barrier 102 can have a relatively high hydrohead value of about 50 centimeters (cm) or more, such as about 100 cm or more, about 150 cm or more, about 200 cm or more, about 250 cm or more, about 500 cm or more, about 750 cm or more, about 1000 cm or more, about 5000 cm or less, or any ranges or values therebetween, as determined according to with ATTCC 127-2008.

By exhibiting the unique combination of low permeability to oxygen and low permeability to liquids, the material of the first barrier 102 may prevent any new or additional atmospheric oxygen from entering the apparatus 100 while maintaining any liquid(s) within apparatus 100. In addition, as discussed, second barrier 104 fluidly separates an oxygen scavenger 120 from the second section 112, while allowing any oxygen disposed in the second section 112 to diffuse into first section 110. Thus, the oxygen scavenger may be able to absorb both oxygen present in the first section 110, as well as oxygen from second section 112 that diffuses through second barrier 104 as the concentration of oxygen decreases in first section 110, without contacting and degrading liquid analytical reagent 114. Therefore, in some aspects, the first section 110 and/or apparatus may have an oxygen concentration of about 50 ppm or less, such as about 40 ppm or less, such as about 30 ppm or less, such as about 20 ppm or less, such as about 10 ppm or less, such as about 5 ppm or less, such as about 2.5 ppm or less, such as about 1 ppm or less, or any ranges or values therebetween. Furthermore, as discussed above, in some aspects, the first section 110 and/or apparatus 100 may be generally free of atmospheric or dissolved oxygen after sealing of apparatus 100. In some aspects, following sealing, the initial oxygen may be depleted in less than 14 days, e.g., less than 12 days, less than 10 days, or less than 8 days. In terms of ranges, following sealing, the initial oxygen may be depleted in an amount of time from 30 minutes to 14 days, e.g., from 30 minutes to 10 days, from 30 minutes to 7 days, from 30 minutes to 1 day, from 30 minutes to 18 hours, from 30 minutes to 12 hours, from 30 minutes to 8 hours, from 1 hour to 4 hours, or any ranges or values therebetween.

While the material of the first barrier 102 may be formed from any material that exhibits one or more of the above properties, in some aspects, the material forming the first barrier 102 may include a metallized or ceramically coated film or may be a material formed from a polyethylene and polyamide copolymer, or a combination thereof. For instance, the metallized or ceramically coated film may include a metallized or ceramically coated synthetic polymer, including polyolefins (such as polyethylene, polypropylene, polybutylene, and the like), polyesters (such as recycled polyester, polyethylene terephthalate, and the like), polyvinyl acetates (such as poly(ethylene vinyl acetate), polyvinyl chloride acetate, and the like), polyvinyl alcohols (such as polyvinyl alcohol, polyethylene vinyl alcohol), and the like); polyvinyl butyrals, polyvinyl chlorides, polyvinylidene chlorides, polystyrenes, as well as combinations and copolymers thereof. Suitable polyolefins may, for instance, include ethylene polymers such as low-density polyethylene (“LDRE”), high density polyethylene (“HDPE”), linear low-density polyethylene (“LLDPE”), and the like, propylene homopolymers (e.g., syndiotactic, atactic, isotactic, etc.), propylene copolymers, and so forth. In some aspects, the first barrier 102 may be formed from a metallized or ceramically coated polyester, such as a metallized polyester, or a copolymer of polyethylene and a polyamide.

Regardless of the materials selected, in some aspects, the oxygen scavenger can be any one or more materials capable of absorbing oxygen without degrading the material of the first barrier 102 and/or second barrier 104. For instance, the oxygen scavenger may be a polyester, a copolyester ether, and/or a substituted or unsubstituted ethylenically unsaturated hydrocarbon, and a transition metal catalyst, an iron-based oxygen scavenger, ascorbic acid, or a combination thereof. In some aspects, the oxygen scavenger may be a glucose or oxidative enzyme such as glucose oxidate, sulfites, phenols, polyphenols, zinc powder, and combinations thereof. However, if a catalyst is used, the scavenger can be activated prior to incorporation into apparatus 100. In addition, the oxygen scavenger 120 can be present as particles, a film, a film layer, a coating, a gasket, combinations thereof, or the like. Furthermore, the oxygen scavenger may be present in an amount sufficient to absorb all oxygen present after sealing of the liquid analytical reagent and oxygen scavenger in the apparatus. In some aspects, the oxygen scavenger may be present in an excess, and may be configured to also absorb oxygen, e.g., all oxygen, introduced via repeated opening and closing of closure 108.

While the figure illustrates the first barrier 102 as being a container that fully surrounds the second section 112, other configurations are possible. For instance, second barrier 104 may form a first section 110 between a closure (such as a cap) 108 and a neck 116 of an apparatus, and a second section 112 between the neck 116 and within the apparatus body 118. In such an aspect, the second barrier 104 may be releasably or fixedly attached to closure 108. Thus, when closure 108 is removed from apparatus 100, the second barrier 104 and oxygen scavenger 120 may be removed with closure 108. In such an aspect, the oxygen scavenger 120 may maintain the low to no oxygen environment during storage, and closure 108 may be replaced with a closure formed from a high oxygen barrier material (which may be the same material as first barrier 102), for dispensing and use. Additionally or alternatively, in some aspects, the second barrier 104 may form a bottle, bag, tube, syringe, cartridge or other device. In other aspects, the first barrier 102 may form a bottle, bag, cartridge or other device that can wholly or partially encompass first barrier 102.

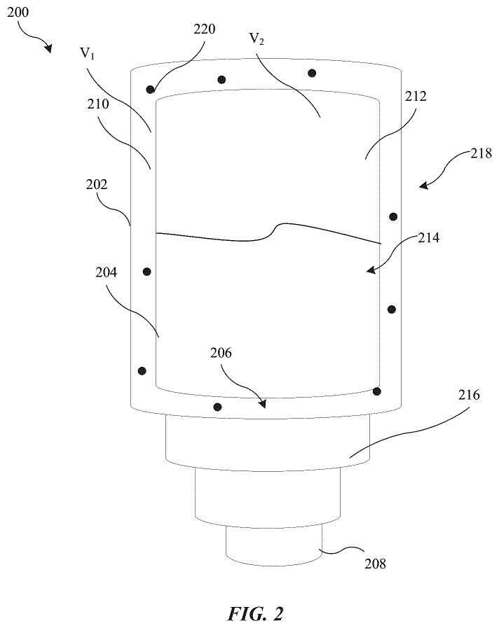

Moreover FIG. 2 may illustrate a further aspect of the present technology, which may include any one or more of the above features discussed in regards to FIG. 1. In embodiments, apparatus or device 200 may be or include a cartridge. As illustrated, in FIG. 2, the apparatus 200 has a first barrier 202, a second barrier 204, an opening 206, and a closure 208, optionally connected to the apparatus body 218 via a neck 216. In the illustrated aspect, the closure 208 may also operate as a connection to a cartridge house, allowing the reagent to flow through the closure 208 when contacted by a reciprocal part in the cartridge house (not shown). In the exemplary figure, the first barrier 202 is shown as defining a first section 210 having a first volume V₁ between first barrier 202 and second barrier 204, which may contain an oxygen scavenger 220. The oxygen scavenger 220 may be according to any one or more of the aspects discussed above. However, it should be understood that in some aspects, the first barrier 202 may be a film disposed on or adjacent to second barrier 204, therefore defining little to no first section volume, as well as any one or more of the orientations discussed above. Furthermore, as illustrated, second barrier 204 may extend around an interior of the apparatus 200 and define a second section 212 having a second volume V₂. The second section 212 may be partially or fully occupied with a liquid analytical reagent 214. The second barrier 204 may be present in the cartridge apparatus 200, separating the oxygen scavenger 220 from the liquid analytical reagent 214, allowing oxygen absorption during the life of the cartridge.

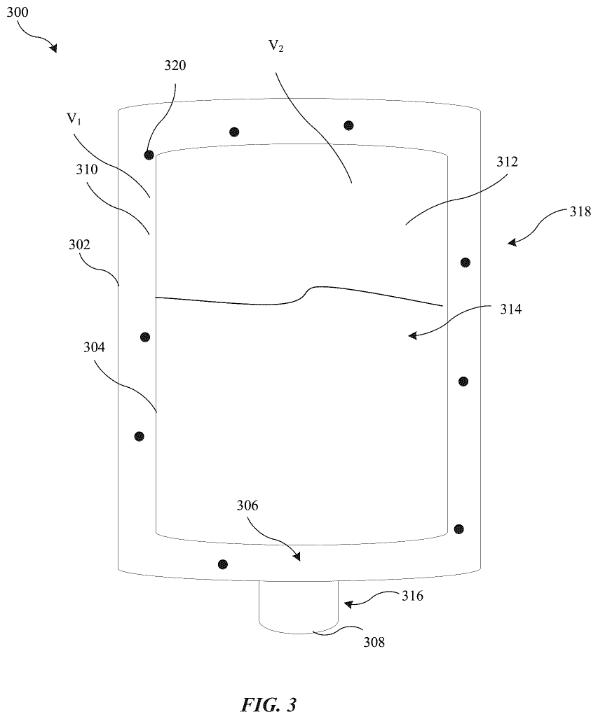

Furthermore, FIG. 3 may illustrate a further aspect of the present technology, which may include any one or more of the above features discussed in regards to FIG. 1. In embodiments, apparatus or device 300 may be or include a bag. As illustrated, in FIG. 3, the apparatus 300 has a first barrier 302, a second barrier 304, an opening 306, and a closure 308, optionally connected to the apparatus body 318 via a neck 316. In the illustrated aspect, the closure 308 may also operate as a connection to a liquid dispenser, or may be a dispenser, allowing the reagent to flow through the closure 308 when activated. (e.g. squeezing, contact with a dispenser part, or other opening methods as known in the art). In the exemplary figure, the first barrier 302 is shown as defining a first section 310 having a first volume V₁ between first barrier 302 and second barrier 304, which may contain an oxygen scavenger 320. The oxygen scavenger 320 may be according to any one or more of the aspects discussed above. However, it should be understood that in some aspects, the first barrier 302 may be a film disposed on or adjacent to second barrier 304, therefore defining little to no first section volume, as well as any one or more of the orientations discussed above. Furthermore, as illustrated, second barrier 304 may extend around an interior of the apparatus 300 and define a second section 312 having a second volume V₂. The second section 312 may be partially or fully occupied with a liquid analytical reagent 314. As illustrated, the bag 300 may have a closure 308 and/or neck 316 that may be inserted into a dispenser or housing. However, in embodiments, the closure may be a threaded closure, such as a cap.

The present technology may be further understood by the following, non-limiting examples.

### Example 1

Commercially obtained R-0820 CAN reagent is composed of ceric ammonium sulfate, sulfuric acid, and water. It is used as an oxidizing titrant in a drop test for sodium nitrite. It is known to have a limited shelf life of only one year when stored at room temperature. That shelf life is further shortened at elevated temperatures. A 6-month accelerated heat stability study was conducted on the R-0820 CAN reagent to evaluate the benefits of storage in a low oxygen environment. An oxygen permeable polyethylene bottle was used as the primary container for the R-0820 CAN reagent in this example. Some of these bottles were then further sealed in mylar bags containing oxygen scavengers to create a low oxygen environment for comparison. Both types were placed in a 40° C. oven and tested multiples times over 6 months. At each checkpoint, the reagent efficacy was determined by testing a 1000 ppm sodium nitrate solution using the following procedure:

Drop Test Sodium Nitrite (1 Drop=40 ppm)
1. Rinse and fill 25 mL sample tube to 5 mL mark with water to be tested.
2. Add 4 drops R-0819 Ferroin Indicator. Swirl to mix. Sample will turn reddish orange.
3. Add R-0820 CAN Solution dropwise, swirling and counting after each drop, until color changes from reddish orange to blue.
4. Multiply drops of R-0820 CAN Solution by 40. Record as parts per million (ppm) sodium nitrite.

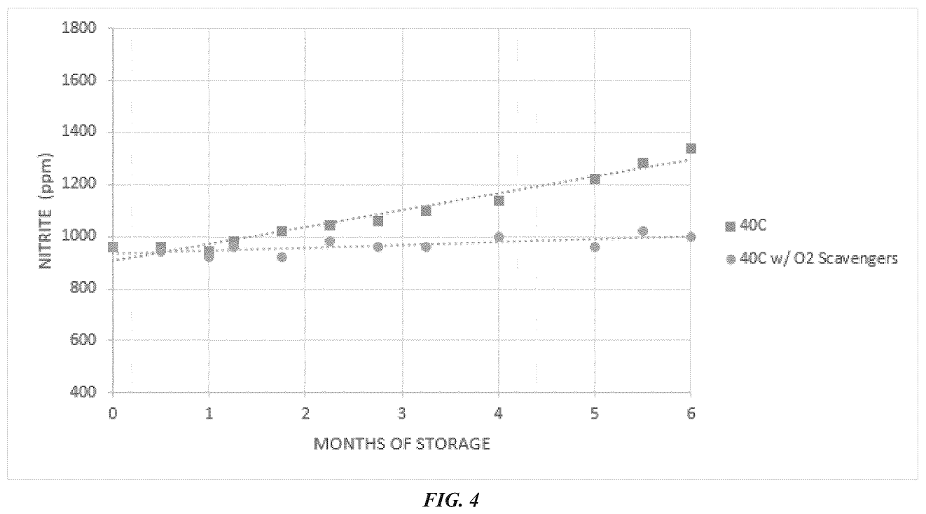

The results of each checkpoint are shown in Table 1 and FIG. 4.

TABLE 1

| Months | 0 | 0.5 | 1 | 1.25 | 1.75 | 2.25 | 2.75 | 3.25 | 4 | 5 | 5.5 | 6 |
|---|---|---|---|---|---|---|---|---|---|---|---|---|
| 40° C. | 960 | 960 | 940 | 980 | 1020 | 1040 | 1060 | 1100 | 1140 | 1220 | 1280 | 1340 |
| 40° C. with | 960 | 940 | 920 | 960 | 920 | 980 | 960 | 960 | 1000 | 960 | 1020 | 1000 |
| O₂ | | | | | | | | | | | | |
| scavengers | | | | | | | | | | | | |

The results show a clear benefit to storing the R-0820 CAN reagent in a low oxygen environment. If the R-0820 CAN reagent remained sealed in an oxygen free environment, it could remain viable for multiple years before its first use and then last at least a further year after exposure to an oxygen environment.

### Example 2

A similar stability study was conducted on commercially available R-0002 DPD reagent #2. This reagent consists of N,N-diethyl-1,4-phenylenediamine (DPD), an acid, and other propriety ingredients and stabilizers. R-0002 DPD reagent #2 is used as a redox indicator for chlorine and other oxidants. Due to its nature as a redox indicator, it is susceptible to slow attack by dissolved oxygen and thus has a limited shelf life of approximately one year. The R-0002 DPD reagent #2 was placed into oxygen permeable polyethylene bottles, a portion of which were sealed in mylar bags with oxygen scavengers and placed in a 40° C. oven to determine the benefits of storage in a low oxygen environment. The reagents were tested periodically using the following procedure:

### Free Chlorine Test

1. Rinse and fill a test cell to the 5 mL mark with water to be tested.
2. Add 5 drops R-0001 DPD Reagent #1 and 5 drops R-0002 DPD Reagent #2 to the test cell. Cap and mix.
3. Match color in the test cell with the color standards. Record as parts per million (ppm) free chlorine (Cl₂).

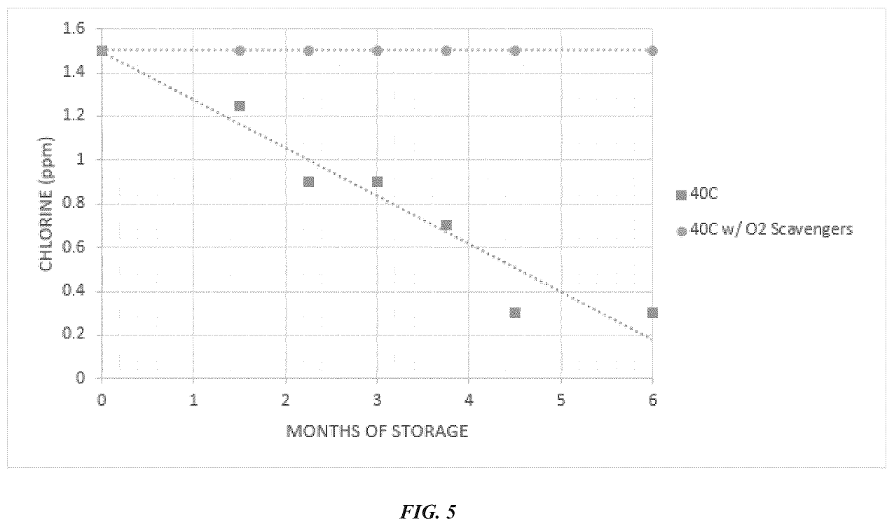

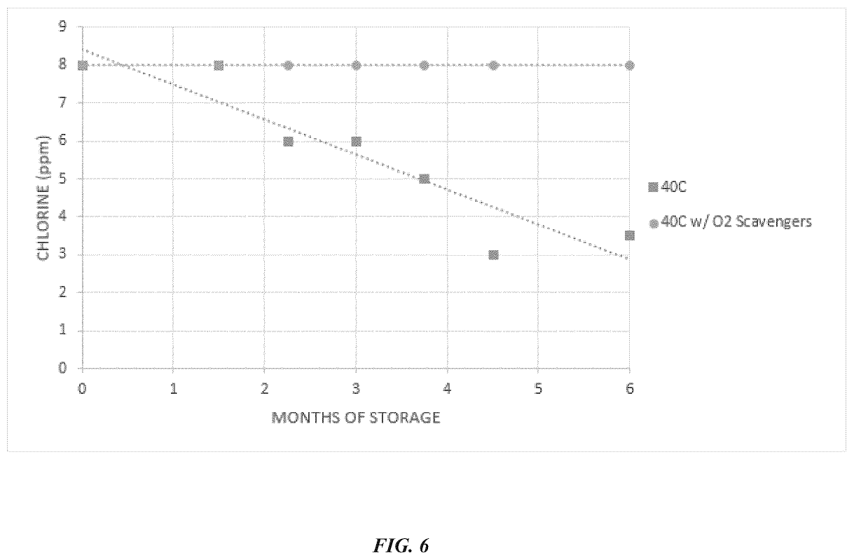

Samples containing 1.5 and 8 ppm of free chlorine were tested over a 6-month period and produced the following results illustrated in Table 2 and FIG. 5 (1.5 ppm) and Table 3 and FIG. 6. (8 ppm).

TABLE 2

| Months | 0 | 1.5 | 2.25 | 3 | 3.75 | 4.5 | 6 |
|---|---|---|---|---|---|---|---|
| 40° C. | 1.5 | 1.25 | 0.9 | 0.9 | 0.7 | 0.3 | 0.3 |
| 40° C. with | 1.5 | 1.5 | 1.5 | 1.5 | 1.5 | 1.5 | 1.5 |
| O₂ | | | | | | | |
| scavengers | | | | | | | |

TABLE 3

| Months | 0 | 1.5 | 2.25 | 3 | 3.75 | 4.5 | 6 |
|---|---|---|---|---|---|---|---|
| 40° C. | 8 | 8 | 6 | 6 | 5 | 3 | 3.5 |
| 40° C. with | 8 | 8 | 8 | 8 | 8 | 8 | 8 |
| O₂ | | | | | | | |
| scavengers | | | | | | | |

As expected, the R-0002 DPD reagent #2 stored in an oxygen environment at an elevated temperature of 40° C. quickly deteriorated. However, the bottles stored in an oxygen free environment showed no change at all. This was further evidenced by the fact that the color of the reagent remained unchanged and completely clear.

Exemplary concepts or combinations of features of the invention may include:
A. A heat stable liquid analytical reagent apparatus that includes a first barrier forming all or a portion of an exterior of the apparatus, and a second barrier, the first barrier being formed from a material having a permeability to oxygen of less than 50 cc/m²/24 hours, and the second barrier forming all or part of a second section within the apparatus, the second barrier being formed from a material having a permeability to oxygen of 50 cc/m²/24 hours or more, where a liquid analytical reagent is contained in the second section and an oxygen scavenger is separated from the liquid analytic reagent by the second barrier.
B. The apparatus of statement A, wherein the first barrier, the second barrier, or both the first barrier and the second barrier are generally impermeable to liquids.
C. The apparatus of statement A or B, wherein the second material is formed from a synthetic polymer.
D. The apparatus of any of statements A to C, wherein the second material is a polyethylene, such as a low-density polyethylene.
E. The apparatus of any of statements A to D, wherein the first material is formed from a metallized or ceramically coated film or a polyethylene and polyamide copolymer.
F. The apparatus of any of statements A to E, wherein the first material is a ceramically coated or metallized polyester.
G. The apparatus of any of statements A to F, wherein the first barrier is in the form of a bottle, bag, or cartridge.
H. The apparatus of any of statements A to G, wherein the second barrier is in the form of a bottle, bag, tube, syringe, or cartridge.
I. The apparatus of any of statements A to H, wherein the second barrier is partially or wholly surrounded by the first barrier.
J. The apparatus of any of statements A to I, wherein the liquid analytical reagent is an oxygen sensitive analytical reagent.
K. Use of the apparatus of any of statements A to J as a pool or spa reagent.
L. A method of preserving a liquid analytical reagent by placing an oxygen scavenger into a first section of a container formed from a first material and placing the liquid analytical reagent into a second section of the container, where a second material separates the first section from the second section, and where the first material has a permeability to oxygen of less than 50 cc/m²/24 hours, and the second material has a permeability to oxygen of 50 cc/m²/24 hours or more.
M. The method of statement K, where the container is not purged with an inert gas.
N. The method of statement K or L, where the second section is in the shape of a bottle, bag, tube, syringe, or cart.
O. The method of any of statements K to M, where the second section forms an enclosed structure.
P. The method of any of statements K to N, where the liquid analytical reagent is placed into the second section prior to incorporation of the second section into the container.
Q. The method of any of statements K to 0, where the oxygen scavenger is an unsaturated polymer, and wherein the oxygen scavenger is activated prior to incorporation into the first section.
R. The method of any of statements K to P, where the oxygen scavenger is configured to absorb all oxygen present in the container.
S. The method of any of statements K to Q, wherein the container is sealed after incorporation of the oxygen scavenger and the liquid analytical reagent, wherein the oxygen scavenger is present in an amount sufficient to absorb all oxygen present upon sealing.
T. The method of any of statements K to R, wherein the oxygen scavenger is present in an amount sufficient to absorb oxygen introduced upon opening of the container.

These examples are not intended to be mutually exclusive, exhaustive, or restrictive in any way, and the invention is not limited to these example embodiments but rather encompasses all possible modifications and variations within the scope of any claims ultimately drafted and issued in connection with the present technology (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy and for which cleaning of debris is needed or desired.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology. Additionally, methods or processes may be described as sequential or in steps, but it is to be understood that the operations may be performed concurrently, or in different orders than listed.

Where a range of values is provided, each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a precursor” includes a plurality of such precursors, and reference to “the layer” includes reference to one or more layers and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

We claim:

1. A heat stable liquid analytical reagent apparatus comprising:
a first barrier forming all or a portion of an exterior of the apparatus, and
a second barrier forming all or part of a second section within the apparatus;
wherein the first barrier comprises a material having a permeability to oxygen of less than 50 cc/m²/24 hours, and the second barrier comprises a material having a permeability to oxygen of 50 cc/m²/24 hours or more, and
wherein a liquid analytical reagent is contained within the second section and an oxygen scavenger is separated from the liquid analytic reagent by the second barrier.

2. The apparatus of claim 1, wherein the first barrier, the second barrier, or both the first barrier and the second barrier are generally impermeable to liquids.

3. The apparatus of claim 1, wherein the second material is formed from a synthetic polymer.

4. The apparatus of claim 1, wherein the second material is a polyethylene, such as a low-density polyethylene.

5. The apparatus of claim 1, wherein the first material is formed from a metallized or ceramically coated film or a polyethylene and polyamide copolymer.

6. The apparatus of claim 5, wherein the first material is a ceramically coated or metallized polyester.

7. The apparatus of claim 1, wherein the first barrier is in the form of a bottle, bag, or cartridge.

8. The apparatus of claim 1, wherein the second barrier is in the form of a bottle, bag, tube, syringe, or cartridge.

9. The apparatus of claim 1, wherein the second barrier is partially or wholly surrounded by the first barrier.

10. The apparatus of claim 1, wherein the liquid analytical reagent is an oxygen sensitive analytical reagent.

11. The apparatus of claim 10, wherein the liquid analytical reagent is a pool or spa reagent.

12. A method of prolonging functionality of a liquid analytical reagent comprising:
placing an oxygen scavenger into a first section of a container formed from a first material; and
placing the liquid analytical reagent into a second section of the container;
wherein a second material separates the first section from the second section, the first material has a permeability to oxygen of less than 50 cc/m²/24 hours, and the second material has a permeability to oxygen of 50 cc/m²/24 hours or more.

13. The method of claim 12, wherein the container is not purged with an inert gas.

14. The method of claim 12, wherein the second section is in the shape of a bottle, bag, tube, syringe, or cart.

15. The method of claim 12, wherein the second section forms an enclosed structure.

16. The method of claim 12, wherein the liquid analytical reagent is placed into the second section prior to incorporation of the second section into the container.

17. The method of claim 12, wherein the oxygen scavenger is an unsaturated polymer, and wherein the oxygen scavenger is activated prior to incorporation into the first section.

18. The method of claim 12, wherein the oxygen scavenger is configured to absorb all oxygen present in the container.

19. The method of claim 12, wherein the container is sealed after incorporation of the oxygen scavenger and the liquid analytical reagent, wherein the oxygen scavenger is present in an amount sufficient to absorb all oxygen present upon sealing.

20. The method of claim 12, wherein the oxygen scavenger is present in an amount sufficient to absorb oxygen introduced upon opening of the container.
